(19) United States
(12) Patent Application Publication
(10) Pub. No.: US 2022/0177115 A1
(43) Pub. Date: Jun. 9, 2022

(54) HIGH-LIFT DEVICE

(71) Applicant: Olivier LAMAILLE, Saint-Maur-des-Fossés (FR)

(72) Inventor: Olivier LAMAILLE, Saint-Maur-des-Fossés (FR)

(21) Appl. No.: 17/600,579

(22) PCT Filed: Apr. 3, 2020
(86) PCT No.: PCT/FR2020/000084

§ 371 Date: Oct. 26, 2021

(30) Foreign Application Priority Data
Apr. 1, 2019 (FR) 1903467
Apr. 1, 2019 (FR) 1903468

(51) Int. Cl. B64C 21/04

(52) U.S. Cl. CPC B64C 21/04; B64C 2230/06; B64C 2230/04

(57) ABSTRACT

The present invention relates to the field of aeronautics and more particularly to a high-lift device and an aerodyne comprising such a high-lift device.

### TECHNICAL FIELD

The present invention relates to the field of aeronautics and more particularly to a high-lift device and an aerodyne comprising such a high-lift device and an airplane security device ASD.

### PRIOR ART

Heavier-than-air aircraft or aerodyne, such as airplanes (fixed-wing aerodyne) can be moved by means of engines or jet engines.

Gliders generally do not have an engine and advance under the effect of the thrust component (opposite of the drag) of the lift of the wing thereof. A wing is a propelling system when the resultant of the aerodynamic forces passes in front of the vertical and supplies a thrust (planes and gliders in descent). In descent, the wings thereof convert the potential energy thereof into speed and lift.

These devices are of interest as they are non-polluting, however they are not always easy to handle, particularly under difficult weather conditions.

As a general rule, an airplane comprises the following subassemblies: drive train; flight controls, onboard equipment, avionics, internal or external loads.

As a general rule, the term glider denotes an aerodyne having a substantial fineness ratio (wingspan between 50 and 200 m) or optimised for gliding flight and motorless flying.

The wing unit is the surface carrying out the lift of an aerodyne by deflecting an air mass, due to the motion thereof. In the case of a “fixed-wing” aircraft (plane or glider), it consists of the wing as opposed to a rotary-wing aircraft (helicopter, gyroplane) or it consists of a rotor. The effective fineness ratio is the value used for calculating the drag induced by the lift. It is generally less than the geometric fineness ratio due to marginal losses and substantial disturbances in wingspan lift distribution; large fuselage, engine pods, it can however be greater when the wing has partitions at the tips thereof, known as winglets.

### Lift and Deflection

A wing generates the lift thereof in the air volume in which it is moving. A wing with a large wingspan moves in a large air volume, whereas a wing with a smaller wingspan works in a smaller volume, of less mass. As the lift is dependent on the deflection of the air mass, a wing with small wingspan must deflect this air mass more (for example by increasing the camber of the wing profile); the vertical component of this deflection is proportional to the drag induced.

Wing with High Fineness Ratio

Although the fineness ratio and surface area are important indicators in terms of the performances of a wing, the most important is the wingspan. The larger the wingspan, the less drag induced.

The difference in pressure between the upper surface and the lower surface of a hydrofoil causes vortices, and in particular marginal vortices at the ends of the wing. As a wing with a high fineness ratio generally has smaller marginal chords, the intensity of these vortices is lower than on thicker wings.

The difference in pressure between the upper surface and the lower surface of a hydrofoil causes vortices, and in particular marginal vortices at the ends of the wing. As a wing with a high fineness ratio generally has smaller marginal chords, the intensity of these vortices is lower than on thicker wings.

Wing with Low Fineness Ratio

A wing with a low fineness ratio has a number of advantages:

Structural advantage: for a given load, a short wing is more rigid (in flexion and torsion) and lighter than a long wing which can bend and twist more. A long and swept wing can twist, which can alter the effect of the ailerons.

Better manoeuvrability: a long wing has greater inertia and therefore a lower angular roll acceleration than a wing with a low fineness ratio. Fighter jets, which are generally supersonic, have a low fineness ratio because they have very fine wing profiles, which increases the chord and reduces the wingspan at equal surface area.

Thinner profile: a short wing, in which the flexion forces are lower, can have lower spars and therefore finer profiles, favourable for high speeds, to push back the critical Mach. This advantageous particularly applies to supersonic planes using profiles with a reduced relative thickness. The relative thickness of the wing on the Concorde is 3%.

Longer profile chord: the Reynolds number of the profile is higher; this can give a slight profile drag advantage, of the order of 2% for a 20% longer chord.

Practical advantage: a wing with a low fineness ratio has a greater internal volume (given that it is normally thicker at equal surface area), which can be used to place fuel tanks, landing gear, or other systems. The development of supercritical profiles, thicker than conventional profiles, has reduced this advantage.

Variable-sweep wing: planes exceeding the speed of sound are sometimes equipped with variable-sweep wings due to the great difference in airflow behaviour between subsonic and transonic or supersonic flight.

In subsonic mode, the induced drag constitutes the main part of the total drag; and the latter decreases when the fineness ratio increases, when the sweep is reduced or zero (so-called “straight” wing).

In supersonic mode, the shock wave generated (which appears on the upper surface when the plane approaches the sonic barrier) produces a much greater drag. A low- or zero-sweep wing, efficient at low speed, has a critical Mach around M 0.75. As the sweep increases, the critical Mach is pushed back more (it can reach M 0.95 for a 45° sweep)¹. The cumbersome and complex system for modifying wing sweep makes it possible to obtain a minimal drag in subsonic mode and in supersonic mode.

Fineness Ratio Values

Examples of Fineness Ratio Value
Low fineness ratio: supersonic Concorde 1.55
Medium: light airplane, 5 to 8. Robin DR-400 airplane 5.35
High: 10 to 15, ATR 12.4, Dash-8 regional airliner 13.4
Very high: >20, Helios 30 solar plane, Nimbus glider 4 39

Helicopter blades are wings with very high fineness ratios:
Robinson R22, rotor diameter 7.67 m, chord 0.188 m, fineness ratio 42

References (Les avions de transport modernes et futurs, André Peyrat-Armandy, Teknea)

High-lift devices (trailing-edge flaps, leading-edge slats, more rarely variable-sweep wing) make it possible to take off and land at lower speed which reduces the distances required and improves safety. A high-lift device is deployed on a plane wing to increase the lift coefficient thereof at low speeds and thus reduce the stalling speed.

To increase the low-speed lift, in particular during the take-off and landing phases, there are several solutions:
increasing the wing area,
   increasing the profile camber by modifying the profile locally with mobile surfaces, flaps or slats,
   increasing the local speed on the profile by propeller or jet engine blowing,
pushing back the effect of stalling by aspirating the boundary layer,
pushing back the effect of stalling by promoting vortex generation (vortex generator, vortex lift).
benefiting from the additional lift provided by the ground cushion during take-off,
asking the engine thrust to “carry” a part of the weight of the plane.

Several solutions can be combined; profile modification is that most used: leading-edge flaps and slats.

In particular, the Vortex Generator system is known, these are local vortex generators which reintroduce speed into the decelerated boundary layer. They are generally used to increase the efficiency of control surfaces at wide angles (upstream from the ailerons, on the sides of the fin, under the T-tail stabilisers, on small-sized canard foreplanes). They are also mounted on some fighter jets and airliners.

Blown flaps are also known.

This system consists of extracting the air from a jet engine and directing it either directly, or via conduits, to the level of the flaps where the air is then on the upper surface. Blowing is only triggered when the flaps are lowered and makes it possible to reduce, or even eliminate, boundary layer separation, which increases the lift.

Particularly used in the 1960s, this system has been more or less abandoned due to the complexity and difficult maintenance thereof. However, it made it possible to use less fuel at take-off.

The present invention relates to a novel high-lift device suitable for an airplane, in particular suitable for a glider, comprising at least three motors and a pipe for distributing the air propelled by the motors on the wings and lifting the assembly (or the aircraft).

This novel original device enables an aerodyne to take off and greatly improves the safety thereof, it also makes it possible to use less fuel during the flight.

### DESCRIPTION OF THE INVENTION

According to an aspect, the present invention discloses a device located at an airplane jet engine [FIG. 7] [FIG. 10], said device being capable of generating an airflow from inlet ports located on the leading edges of a wing [FIG. 2] (2), by an airplane engine or jet engines, said airflow being directed by channels and controlled by a turbine (3) located in the wing profile, said device comprising a metallic chamber which surrounds the jet engine of an airplane [FIG. 8] (15)

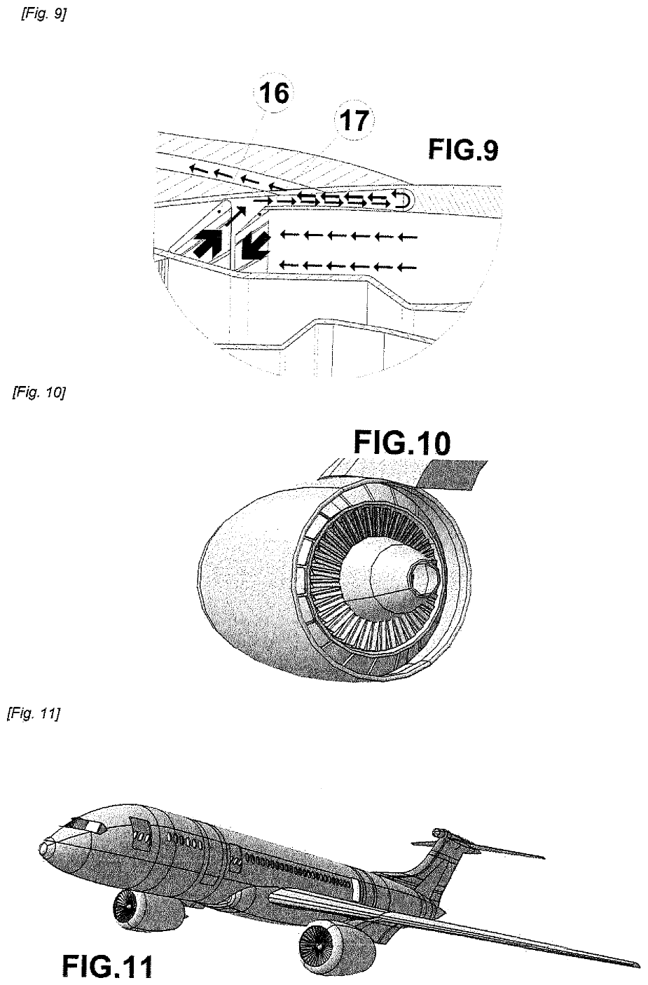

Winglets upstream from the thrust reversers and downstream winglets [FIG. 9] (16), [FIG. 10] [FIG. 11], slightly larger than those upstream, said winglets being designed such that lowering said winglets makes it possible to direct the airflow in the chamber (15) to a high-lift device located at the wings.

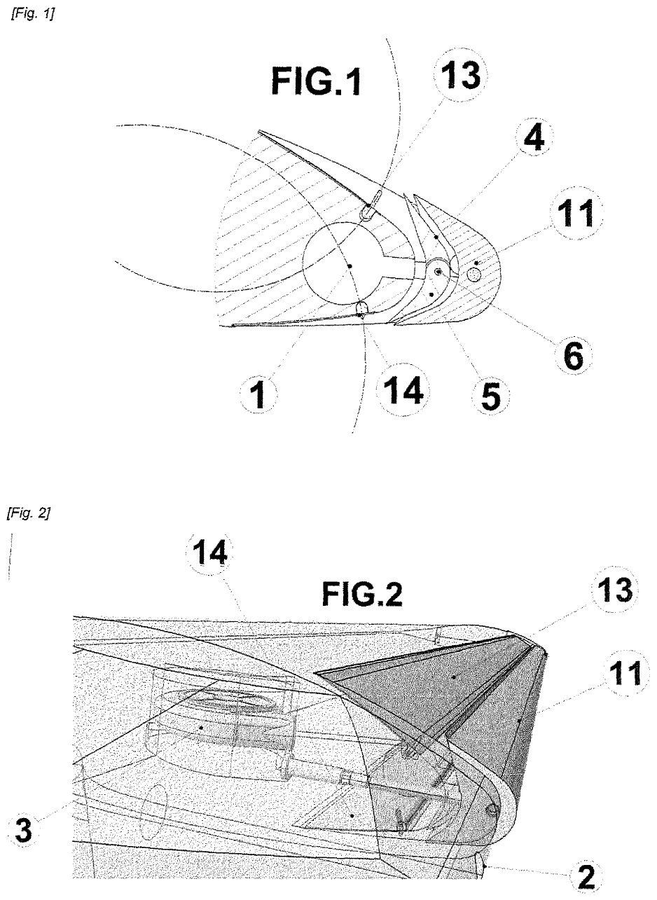

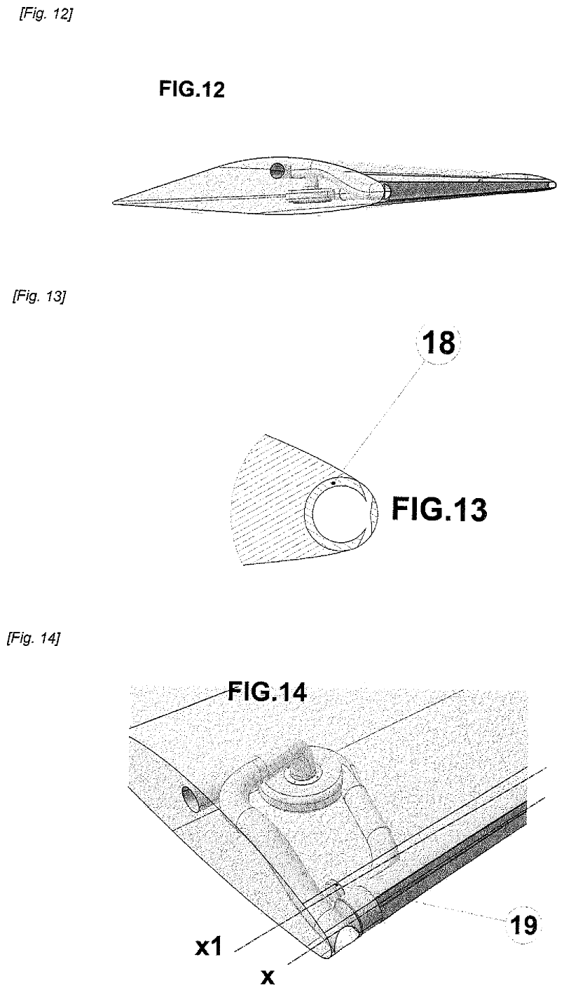

According to another aspect, the invention relates to a high-lift device characterised in that it comprises panels [FIG. 2] (13, 14), one on the upper surface and the other on the lower surface of a wing profile moved by electric motors and which allow a clearance, three successive leading edges in the wing profile [FIG. 1] or a cylinder in a wing profile [FIG. 12] [FIG. 13] (18).

According to another aspect, the invention relates to a high-lift device wherein the panels [FIG. 1] (13, 14) are mobile and comprise, at the rear ends thereof, a pivot link, and at the front ends thereof, two fingers having a cogwheel, said panel being in turn toothed and integrated in toothed grooves of the profile and wherein the electric motors are located on either side of said panels.

According to another aspect, the invention relates to a high-lift device wherein the first leading edge is fixed and integral with the wing, and comprises a tube wherein the ends are occluded and comprising a slot (1) on the flank allowing the passage of an airflow [FIG. 1] inside the leading edge, a pipe connects this tube to a turbine;

the second leading edge comprising two mobile parts [FIG. 1] (4, 5) joined by a shaft (6) whereon two push cylinders [FIG. 5] (7) located at shaft end allow a longitudinal clearance which renders this assembly rigidly connected to the shaft (8). This shaft (8) consists of one or more cam(s) (9), the rotation thereof (8) enables the rotation of the two parts (4, 5), which allows different angular settings, the assembly (4, 5, 7, 8, 9) is held by a cylinder (10) located on each side of the shaft [FIG. 5]

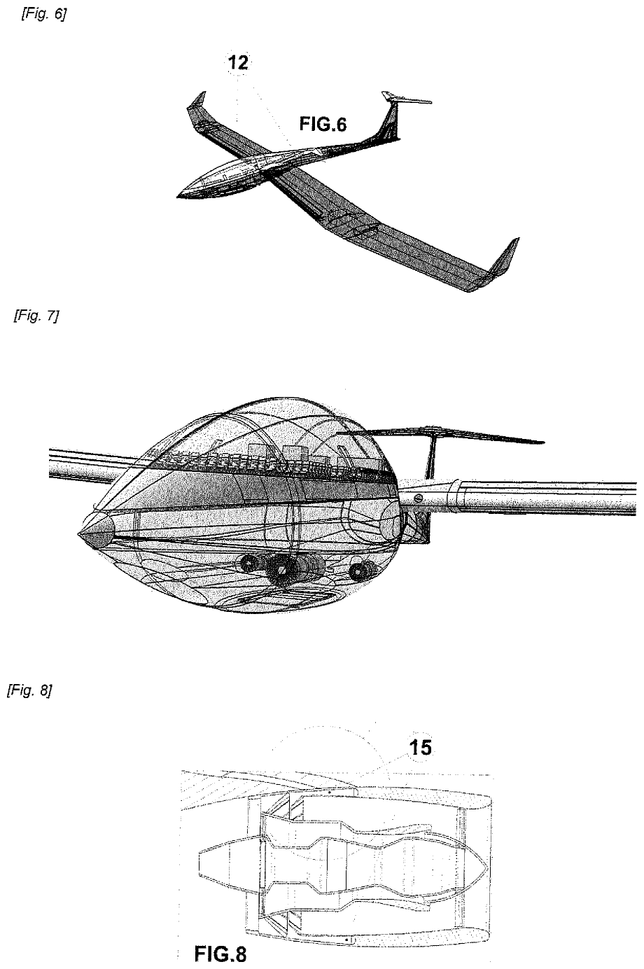

The third leading edge (11) covers all of the first two leading edges and is held by two cylinders having a longitudinal displacement and which are fastened inside the wings [FIG. 6] (12).

According to another aspect, the invention relates to another way to embody this high-lift device [FIG. 12] [FIG. 13] (18), wherein the machining of two notches on the flank of the cylinders determines the angle whereby the airflow emerges therefrom to flow on the upper surface and lower surface simultaneously.

According to another aspect, the invention relates to a high-lift device wherein the cylinder is mobile and rotatable on a shaft (x) [FIG. 14], rotation and locking being carried out by cogwheels (19) in contact with shaft ends (x1).

According to another aspect, the invention relates to an aerodyne comprising a high-lift device according to the invention.

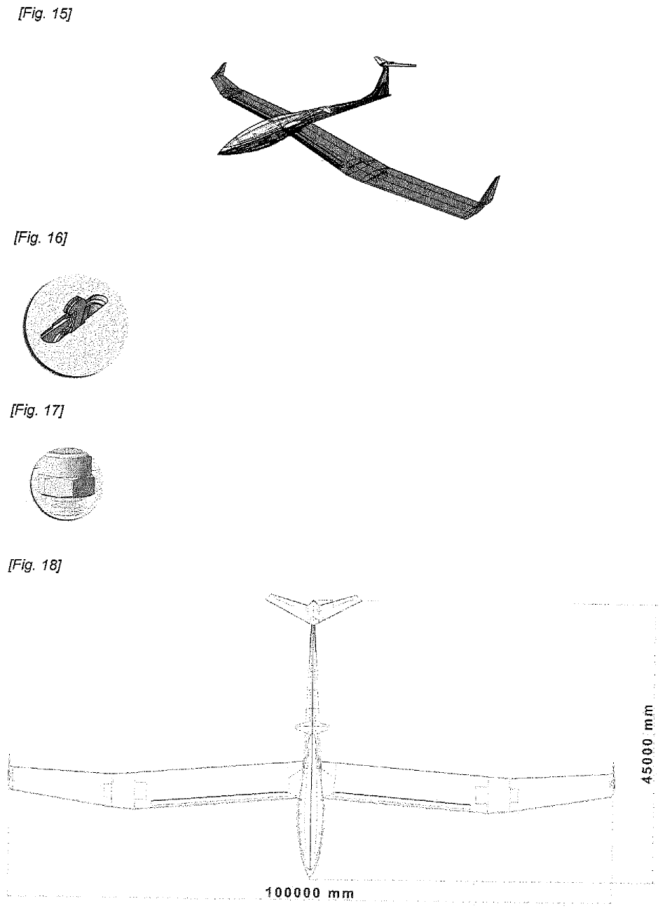

A GLX5 (Glider x5) glider is of the size of an airplane (these measurements are by way of indication) having a wingspan of 100 metres and a length of 45 metres [FIG. 18]

The “GLX5” is intended for glider pilots who know the vast possibilities of this type of aircraft, used for its fineness as, to date, there is no equivalent. The invention according to a specific aspect relates to a glider comprising three turbojets, the so-called largest representing alone a thrust equivalent to the other two combined.

The numerous devices attributed thereto apply to an airplane.

According to an embodiment, the invention according to a specific aspect relates to an ovoid-shaped glider comprising a conical fuselage which tapers to the vertical tail.

The invention according to a specific aspect relates to a glider comprising a subassembly of parts comprising, on one hand, a cradle, which connects the wings, it contains the engine room, just above, an area dedicated for transport, a cockpit.

These parts are assembled together by fusible bolts [FIG. 17], and four hooks [FIG. 16] distributed on a platform, whereon the second part rests.

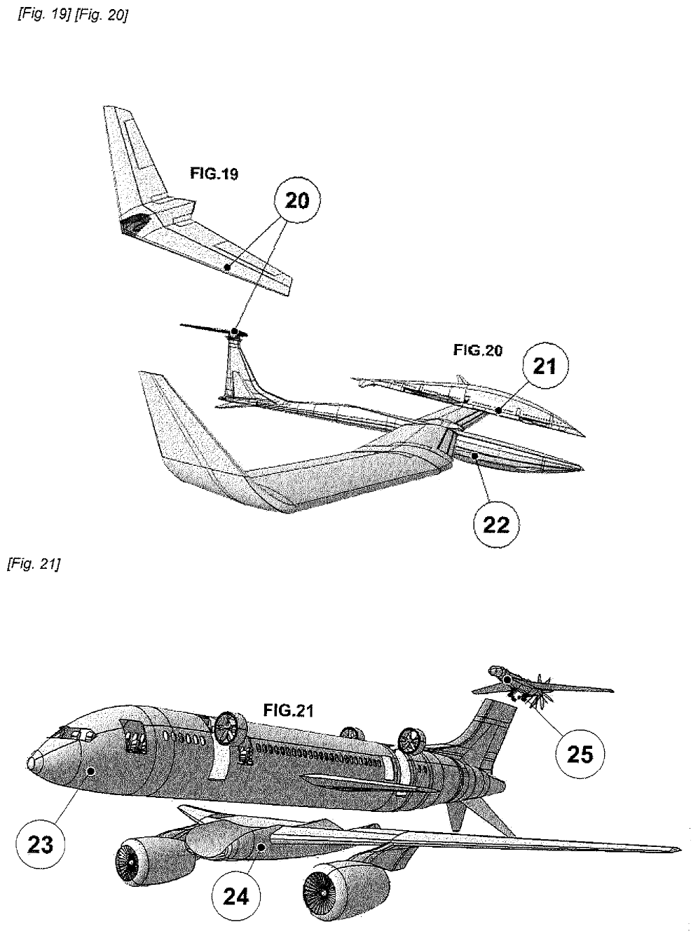

This is the main rescue module characterised in that it is an aircraft. The cockpit forms the final part of this assembly, it is located in the depth which is also an aircraft (sailwing) [FIG. 19] (20).

However, this arrangement can be modular. The cockpit can be located in the ovoid part, to the front, which is the most standard, and the aircraft located at the fin can be a drone, [FIG. 21] (25) allocated to multiple other tasks that could be attributed thereto, rescue module geolocation assistance, GL x5 flight recorder storage location, etc.

These three parts are part of a device known as an ASD or airplane security device.

### BRIEF DESCRIPTION OF THE FIGURES

Drawing 1: FIG. 1. Representation of a sectional view, of a leading edge of a wing profile and the device, FIG. 2 Representation of a perspective view of a wing and the high-lift device.

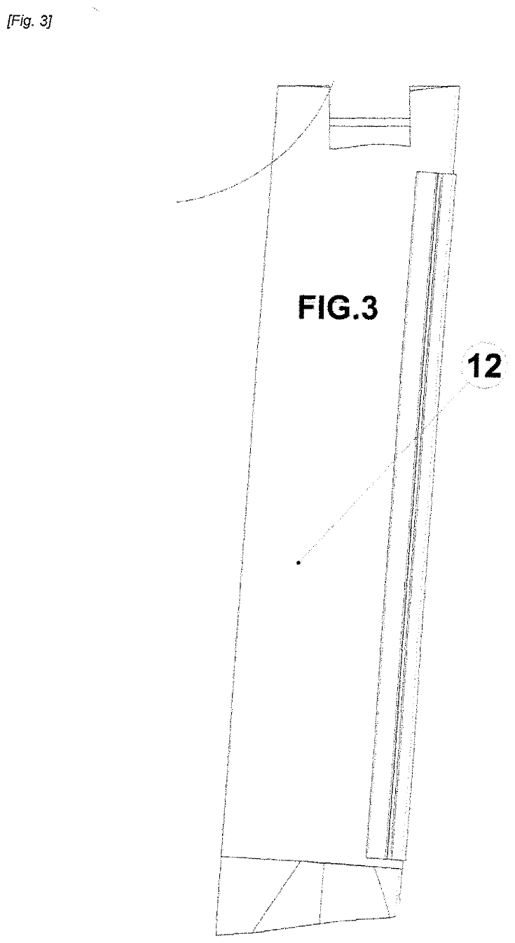

Drawing 2: FIG. 3 Representation of a top view of a wing of a wing part and the device in the active phase.

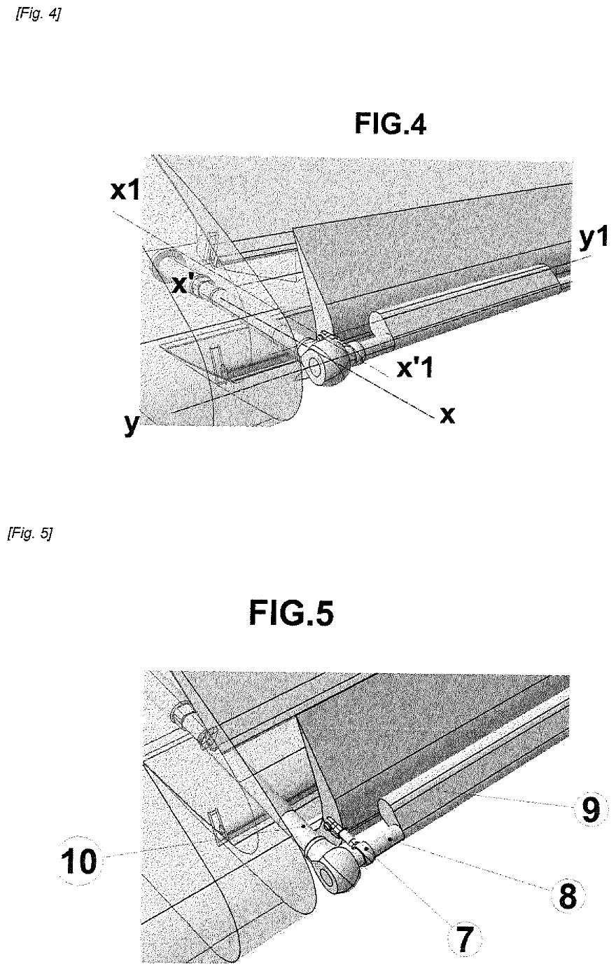

Drawing 3: FIG. 4 Representation of the high-lift device without the final leading edge. Perspective view of the second leading edge and the device allowing the clearance thereof and FIG. 5 Representation of another viewpoint of FIG. 4.

Drawing 4: FIG. 6 Representation of an overall view of the device on the GL x5 FIG. 7 Representation of the GL x5 and the location of the jet engines thereof FIG. 8 Representation of sectional view of a jet engine and the device for capturing the airflow.

Drawing 5: FIG. 9 Representation of enlarged sectional view of the device for capturing the airflow at the jet engines FIG. 10 Representation of the jet engine and the winglet device for deviating the airflow FIG. 11 Representation of an airplane.

Drawing 6: FIG. 12 Representation of another device fulfilling the same function as the high-lift device FIG. 13 Representation of sectional view of the leading edge of a wing profile of this further high-lift device FIG. 14 Representation of a wing equipped with this further device for boosting the airflow.

Drawing 7: FIG. 15 Representation of an aerodyne comprising the high-lift device, FIG. 16 Representation of a release hook FIG. 17 Representation of fusible nut FIG. 18 Representation of top view of GL x5.

Drawing 8: FIG. 19 Representation of an ASD device, rescue module located at the end of the fin FIG. 20 Representation of ASD device of the three constituent parts FIG. 21 Representation of ASD device and the three parts thereof on an airliner in active phase.

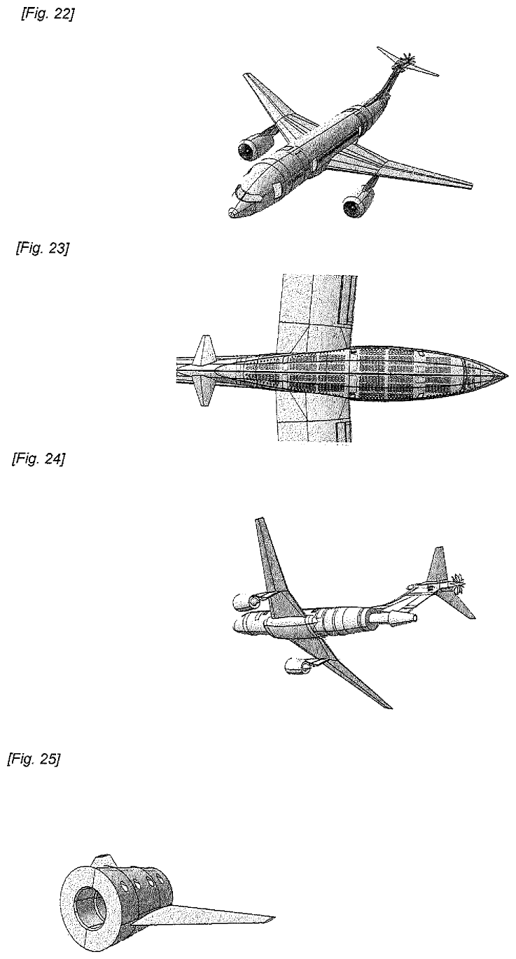

Drawing 9: FIG. 22. Representation of an airplane equipped with the ASD device FIG. 23 Top view of the GL x5 equipped with the ASD device FIG. 24. Representation of the rear conical end of the fuselage of this airplane and of the shaft supporting the device Sigma, without the latter: FIG. 25 Representation of the device Sigma represented by conical bases perforated at the centres thereof, which are mobile whereon two symmetrically opposite flight control surfaces are mounted.

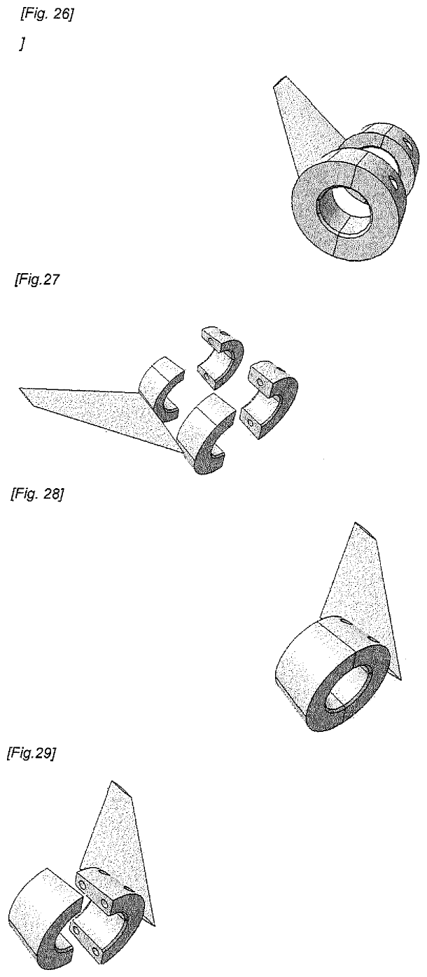

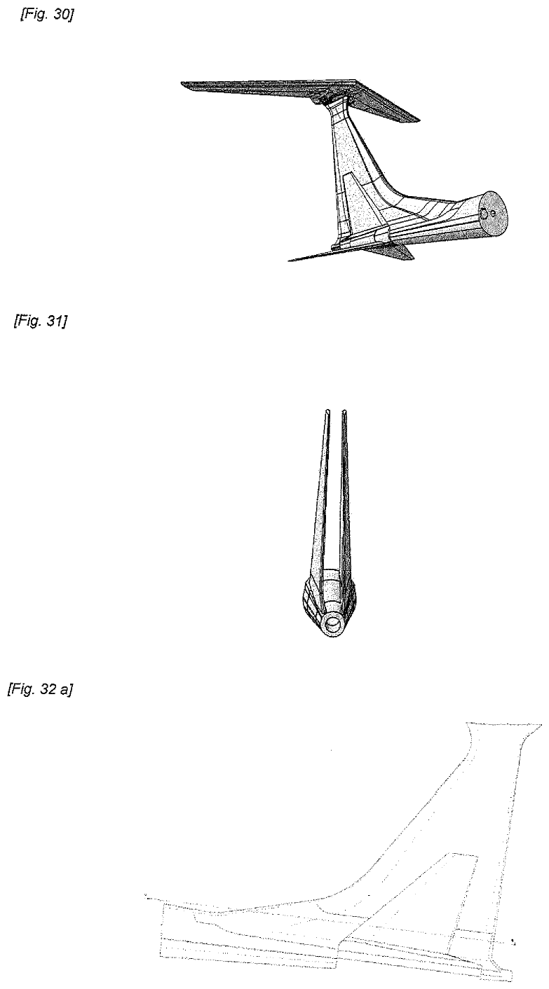

Drawing 10: FIG. 26. Representation of dismounted assembly in FIG. 25 FIG. 25 Representation of one side, right mobile unit, right flight control surface, detailed view of assembly FIG. 27. Representation of right mobile right flight control surface assembly FIG. 28 Representation of left mobile left flight control surface assembly FIG. 29 Representation of detailed view of left mobile assembly, left flight control surface

Drawing 11: FIG. 30 Representation of the device Sigma integrated in a fin having a conical base in active phase FIG. 31 Representation of the device Sigma assembly of the two conical bases in passive phase device idle. FIG. 32 a] Representation of rear end of fuselage wherein the conical assemblies rotate and of the fin provided with flight control surface cavities for housing same [FIG. 32 b];

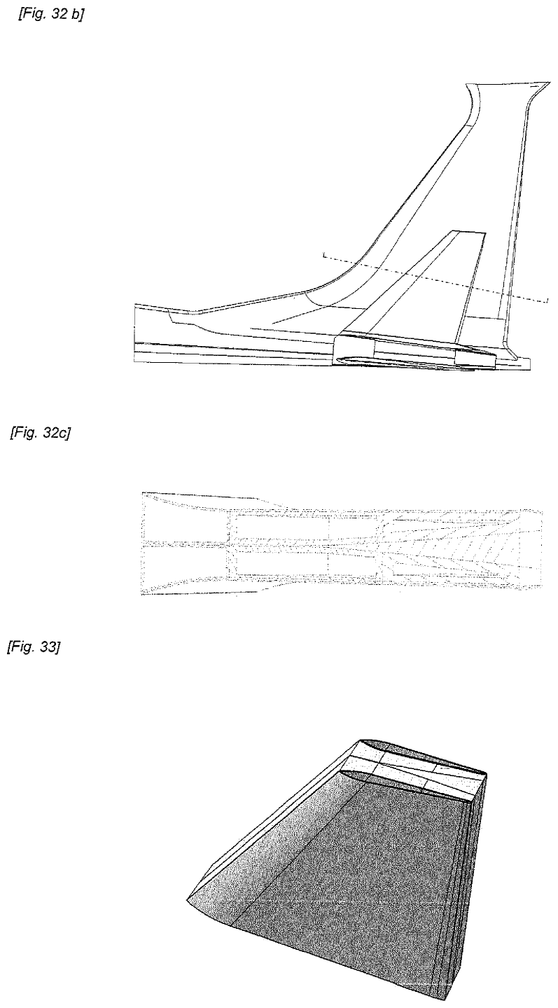

Drawing 12: [FIG. 32 b] Front representation of sectional view of fin for next view FIG. 32 c, sectional view of fin when the device is in the passive phase (idle): FIG. 32 c Representation of a sectional view of the Beta device, composed of several parts; FIG. 33 Representation of warp of panel beta device alone is in active phase.

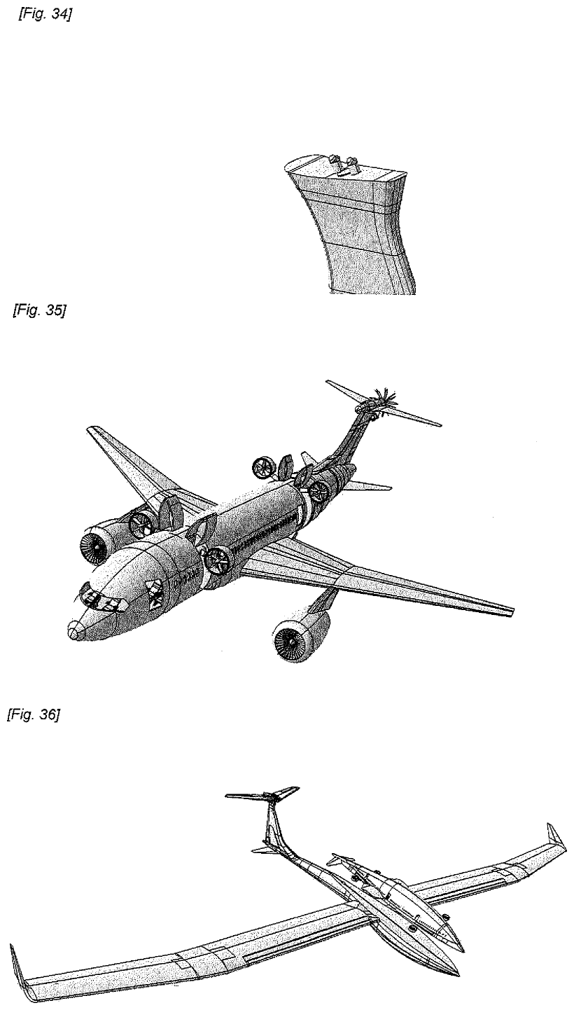

Drawing 13: FIG. 34 Representation of the clamp Tau device for locking to the fin the rescue module located at the end of the end fin at the deck-landing zone FIG. 35 Representation of this airplane and its rescue theta device in the active phase composed of four fans equipped with propellers FIG. 36 Representation of GLx5 and the rescue theta device thereof in the active phase composed of four fans equipped with propellers.

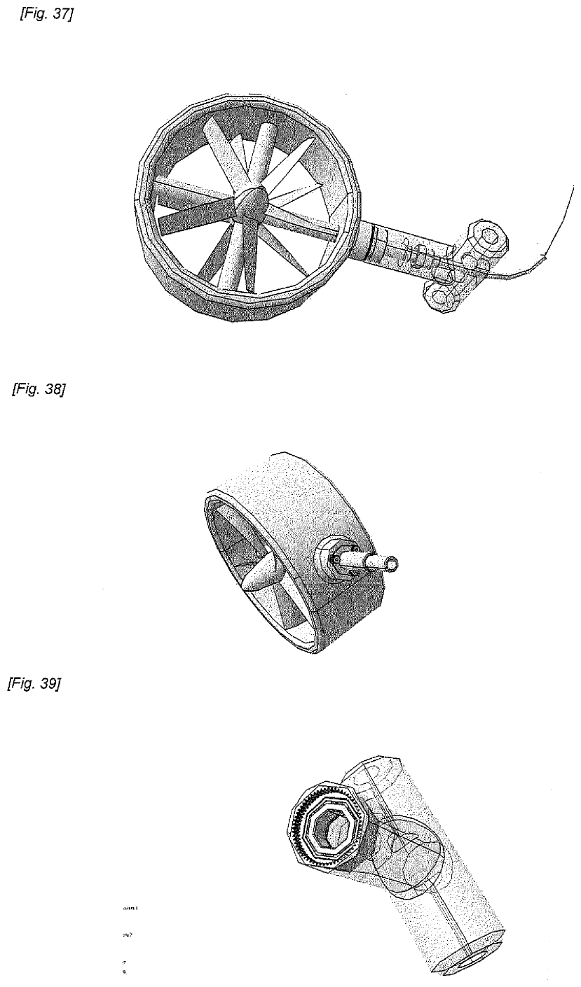

Drawing 14: FIG. 37 Representation of an element of the theta device overall view of one of the arms and of its fan FIG. 38 Dismounted representation of this assembly of the arm; fan first part FIG. 39 Dismounted representation of this assembly of the fan arm, second part

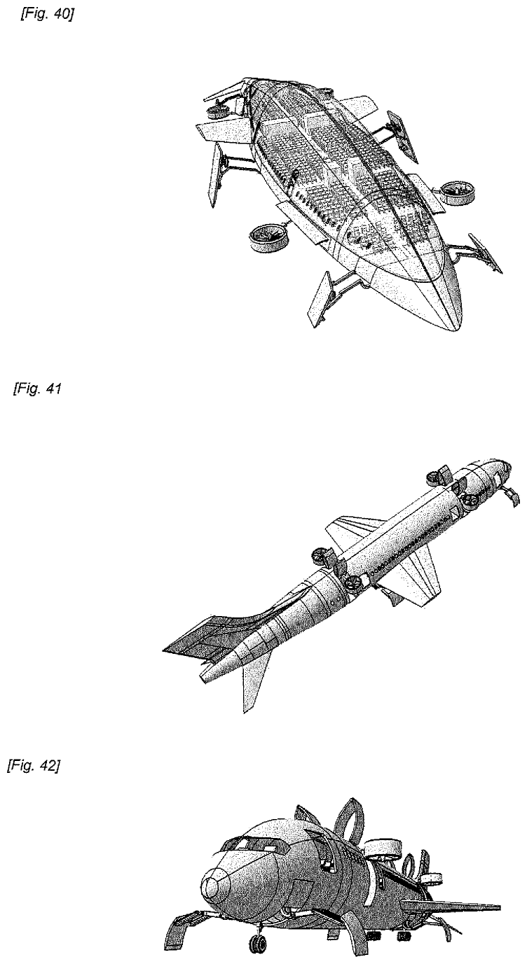

Drawing 15 FIG. 40 Representation of rescue module of GLx5 and of its theta device active phase FIG. 41 Representation of fuselage and of its theta device active phase. FIG. 42 Representation of the landing gear Iota device active phase gear deployed

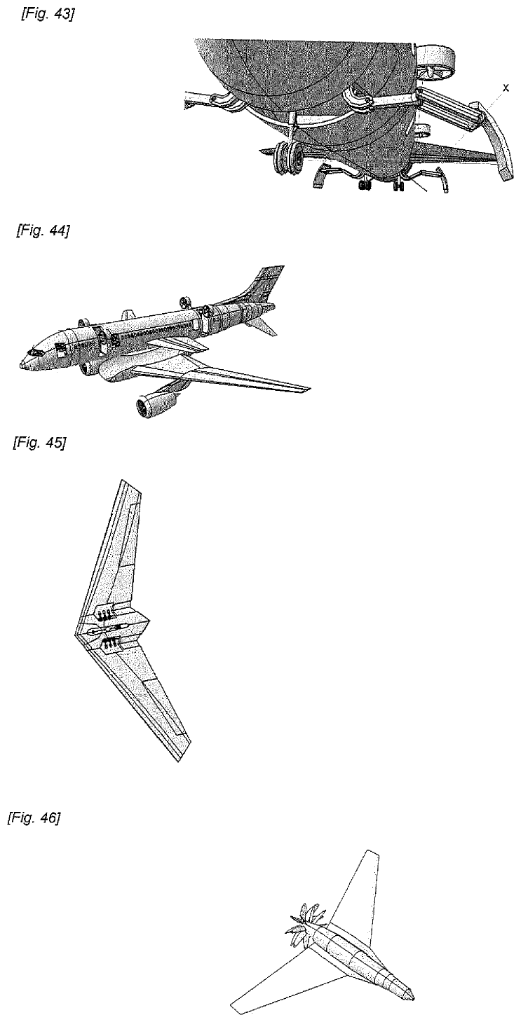

Drawing 16: FIG. 43 Representation of the Iota device, of the different constituent elements of articulated landing gear FIG. 44 Representation of airplane equipped with its devices in active phase FIG. 45 Representation of the third part of the ASD device having the rescue module function, in active phase (fixed-wing aircraft) and the elevator function in passive phase FIG. 46 Representation of a rescue module, though different, the same features can be seen as in FIG. 45 aircraft equipped with a fixed wing unit having the elevator function in passive phase.

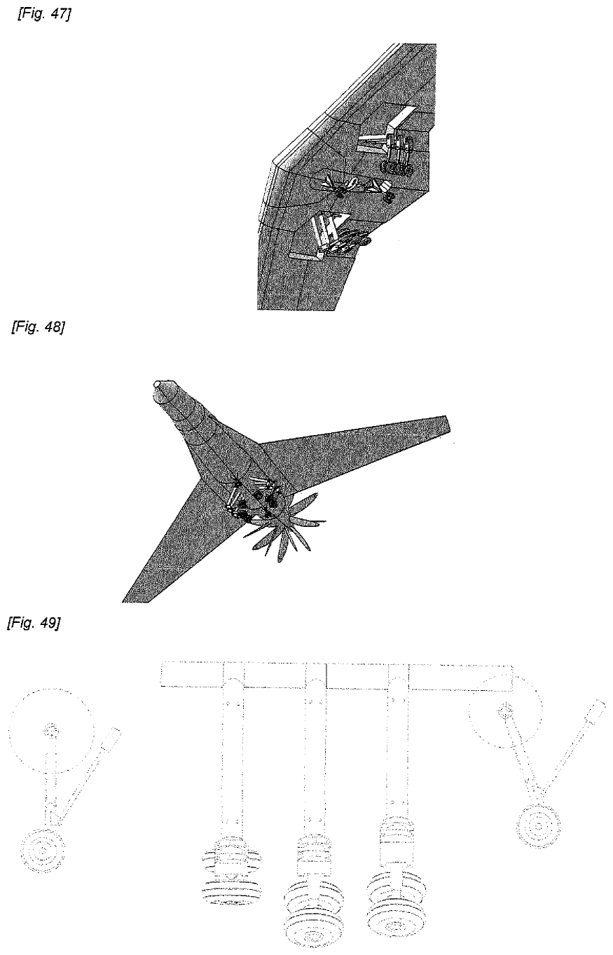

Drawing 17 FIG. 47 Representation of the articulated landing gear of this rescue module FIG. 48 Representation of the articulated landing gear of this rescue module FIG. 49 Representation of the articulated landing gear of this rescue module.

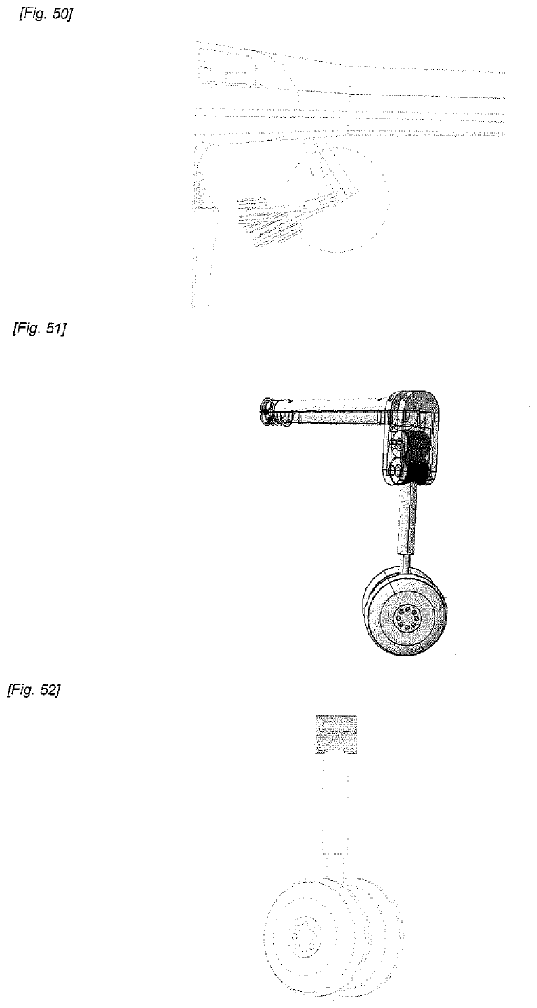

Drawing 18: FIG. 50 Representation of front half-view of a rescue module and of the articulated landing gear clearance FIG. 51 Representation of an arm and landing gear assembly FIG. 52 Representation of an element of the landing gear

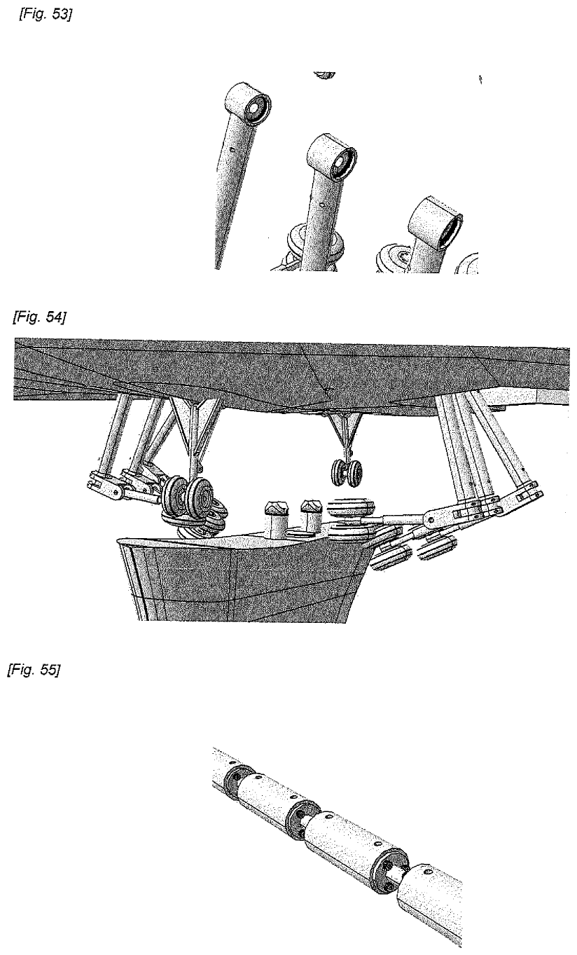

Drawing 19: FIG. 53. Representation of the ring gear device present in each of the arms enabling each to have a rotation FIG. 54 Representation of a rescue module and of the landing gear thereof at the top of the fin. FIG. 55 Representation of one of the shafts equipped with pinion whereon the arms thereof rotate.

### DETAILED DESCRIPTION OF THE INVENTION

I have developed two versions fulfilling the same function for more clarity I have identified respectively version 1: Epsilon, version 2: Lambda and a sub-device associated therewith, Mu, which makes it possible to convey the airflow thereto.

Each of these devices is based on a wing profile whereon the latter are mounted, thus in the first version, Epsilon [FIG. 2] the device is formed from two panels on the upper surface and the other on the lower surface which allow a clearance. They owe this mobility to the rear ends thereof which have a pivot link, whereas those located to the front are equipped with two notched fingers at their ends they are captive in the grooves [FIG. 1] present in the profile. Two electric motors located on either side equipped with cogwheels perform this rotation. The movement of these two surfaces makes it possible to modify the profile of the wing FIG. 1. On the edge of these panels, there are three successive leading edges [FIG. 1] in the wing profile.
The first leading edge is fixed and is integral with the wing, it is characterised by a slotted tube (1) on the flank passing along same, and the ends whereof are occluded located inside the leading edge a pipe connects this tube to a turbine. The slot present along same allows the passage of an airflow [FIG. 1].

An airflow is extracted by the pipes; by an additional device Mu to the thrust reversers located at the jet engines thereof, and by inlet ports located on the leading edges of each wing [FIG. 2] (2). This air is controlled by a turbine (3) concealed in the wing profile.

This device Mu is composed of a metallic chamber which surrounds the jet engine [FIG. 8] (15) and of winglets upstream from the thrust reversers. This chamber in idle phase is closed by the winglets positioned upstream.

In active phase, when the device is actuated, the thrust reversers, composed of slightly larger winglets [FIG. 9 FIG. 10] (16) located downstream, and the winglets located upstream are lowered simultaneously (17), which makes it possible to direct the airflow in the chamber (15) to the high-lift device.
The second leading edge is composed of two mobile parts [FIG. 1] (4, 5) joined by a shaft (6) whereon two push cylinders (7) located at shaft end rigidly connected to the shaft (8), allow a longitudinal clearance; connects the assembly to the shaft (8) consisting of two cams (9). The rotation of the shaft (8) enables the rotation of the two parts (4, 5) which allows different settings. The assembly (4, 5, 7, 8, 9) is held by a cylinder (10) located on each side of the shaft. The two parts owe their mobilities [FIG. 1] to two electric motors present therein.
The third leading edge (11) covers all of the first two and is held by the two cylinders which have a longitudinal movement the latter are fastened inside the wings (12).

Operating principle: the third leading edge [FIG. 2] (11) advances longitudinally, shaft (x, x′) by means of the cylinders (10). The two mobile parts (13) (14) FIG. 1 represented by two panels, one on the upper surface and the other on the lower surface are lowered in the recesses thereof and are locked. The movement of these two surfaces makes it possible to modify the profile for the proper operation of the device. The airflow is sent by the jet engines and controlled by the turbines concealed in the profiles (3). This air escapes via the slot present in the first leading edge and hits the two mobile parts represented by the second leading edge (4, 5). These two mobile parts allow an angular setting, thanks to the rotation of the two cams which allows the displacement of the shaft (6) (x1, x1′) longitudinally, this is kept tensioned by the push cylinders (7). The release of the second leading edge against the wall of the third by the part (9) enables a clearance of the parts (4, 5) by an electric motor, which allows the possibility of directing the airflow which hits the two parts of the mobile leading edge.

In the second version: Lambda:

The device is much simpler in its design [FIG. 13]. The leading edge of the wing has been replaced by a cylinder which merges with the wing profile (18); Here, the direction of the airflow cannot be mechanically controlled, the machining of two notches present on the flank of the cylinder determines the angle of attack whereby the airflow emerges from the cylinder to flow on the upper surface and the lower surface simultaneously. The cylinder is rotatable on the shaft (x) [FIG. 14], owes its rotation and its locking to a cogwheel (19) in contact with the ends thereof, shaft (x1).

Operating principle of the other high-lift device [FIG. 12] in standby the cylinder occludes the pipe through which the airflow passes [FIG. 14] In the active phase, once the cylinder has rotated [FIG. 13], and then been locked in the correct position, the airflow from the jet engines and the turbine escapes through the two oriented notches on the wing profile (18).

### Airplane Security Device ASD

This airplane security device converts the fuselage or a part of the fuselage into a rescue module in the event of damage [FIG. 19; FIG. 20; FIG. 21]. Three parts, which the fuselage, the wings, and the elevator [FIG. 19] [FIG. 20] (20; 21; 22) FIG. 21 (23; 24; 25) are distinguished. They can be detached from one another, each of its parts contain sub-devices which perform this transition, identified by a letter of the Greek alphabet for more clarity.

The first part of this assembly is composed of the rescue module, this has a device Sigma [FIG. 20] (21) [FIG. 21] (23) which consists of two symmetrically opposite ailerons of symmetrical convex shapes. They have the specificity of merging with the aircraft wings of the part (2) [FIG. 22] [FIG. 23], each aileron has a flight control surface controlling the rescue module, not represented here. They are located at the wing root* (term used to visualise the positioning).

This rescue module incorporates an Alpha device [FIG. 24], it is characterised by the conical shape of the rear end thereof, which allows a mobile assembly [FIG. 25] composed for each thereof, [FIG. 26; FIG. 28] of two semi-circles [FIG. 27; FIG. 29] having the same shape but not the same dimensions. On which are assembled on the slightly off-centre panel with respect to the centre of the cone two stabilisers equipped with flight control surfaces, [FIG. 25] positioned thus at the fin. This feature enables these stabilisers to merge with the fin when the device is not actuated.

So that the conical assembly and the stabilisers thereof can pivot, this fuselage allows a shaft whereon this assembly is positioned [FIG. 24. FIG. 32a]. The stabilisers pivot in opposite directions thanks to an electric motor, they allow a clearance of 180°. This allows different settings.

These stabilisers act as backup elevators, when the main elevator located at the end of the fin [FIG. 30] is no longer there, in order to ensure the stability and control either of the airplane or of the rescue module.

So that these stabilisers can merge with the fin, they are of symmetrical biconvex shape, [FIG. 31], this fin allows a Beta device [FIG. 32c] which is concealed in the vertical tail. This tail allows two metal panels moulded in the shape of the stabilisers, these panels have the specificity of warping in order to fill the gap left when the stabilisers come out of their position [FIG. 32c, FIG. 33], in order to ensure a minimum drag.

This Beta device [FIG. 32c] is based on one of the characteristics of the metal, the warp thereof when it is under stress. The device controls this warp by converting these panels into convex planes. These two panels represented by these cavities distributed symmetrically on either side of the fin, delimited by a rigid part at the centre thereof, are attached to a rubber membrane that has been rendered hermetic. The latter is composed inside of several parts each having a difference in thickness separated by a partition, [FIG. 32c] which enables the mechanical warp of these panels once air is injected inside these walls.

At the end of this fin, there is a horizontal plane inside which the Tau device is located [FIG. 34]. The latter is composed to two cylinders equipped with clamps at the ends thereof, which slide in two cylinders to the structure of the drone (elevator) or two cylinders of a slightly greater diameter allow the passage of the device and the bottom of which has for each a ring whereon these clamps are locked. These clamps make it possible according to the selected configuration either to grip and lock or release the drone (the elevator).

The fuselage contains a Theta device [FIG. 35, FIG. 36] composed of four fans distributed on either side thereof concealed inside a specific compartment, these are the backup propulsion means of this rescue module.

This device is composed of four hollow arms of cylindrical shape [FIG. 37], having a cylindrical base, assembled perpendicularly to the arm, on the panel of this base, there is a hole which allows the assembly of the elements composing this device. This base enables the passage of a shaft which connects the arm and fan assembly to the fuselage structure [FIG. 35. FIG. 36]. These arms pivot in rotation on the respective shafts (x) thereof via electric motors present in the base thereof.

Inside these arms, at the ends, there is a device composed of a ring gear which is mounted on a bearing, the whole is rigidly connected to the arm [FIG. 39]. At the ends thereof, the fans [FIG. 38] having the same cylindrical base but having a shaft of a slightly smaller diameter which enters inside this cylinder and the end whereof has a threading, which enables the assembly of the two elements, are positioned. Around this section, there are three electric motors concealed in the cylindrical part only showing the three pinions [FIG. 38], positioned so as to ensure the rotation of the fan via the ring gear.

In each of these fans, two shafts intersect, at the junction thereof, there is an electric motor [FIG. 37] equipped with a propeller with several blades. These fans pivot in rotation about the shaft thanks to the three electric motors present in the fan junction. The four electric motors are powered with electricity by batteries housed in the fuselage. They represent the propulsion means of this rescue module.

One of the main functions of this Theta device is that of slowing down the fall of this rescue module, when the fans are positioned somewhat horizontally (they are parachutes). They can be attributed other functions, they also serve as an air brake when the fans are in the vertical position.

This rescue module comprises an Iota device [FIG. 41], (the landing gear) characterised by the shape thereof allowing it to merge along the fuselage in the case of an aircraft, located at the front and at the rear. This feature enables it to serve as a hatch for the main landing gear in the passive phase and as landing gear in the active phase. They are reinforced to support the rescue module weight, the deployment thereof allows landing on any type of terrain, including those with a slope.

This device is composed of six articulated arms distributed around this rescue module. Each arm includes four links and is composed of four parts [FIG. 43], the deployment thereof is performed by electric cylinders, not represented here. The first part is connected to the housing where the landing gear is located, the two metallic arms thereof have a circular shape to extract the entire device without it touching the outer walls of the module structure. They have a rotation on the shaft (x). Parts two and three enable the deployment of the device in rotation on the respective shaft (X) thereof, the end of the final part is connected to a hatch, which conceals the entire device in the housings where they are located. These gear hatches are characterised by the bevel shapes of each thereof at their ends, making it possible to penetrate the ground [FIG. 41] to stabilise the module when the latter lands vertically.

The role of the Iota device is to damp the impact on the ground but also to ensure a horizontal plane for this rescue module regardless of the type of terrain encountered.

The second part of this assembly serves as a receiving base, it is composed of a cradle wherein the wing structures are assembled [FIG. 20 FIG. 21] and of the airplane engines. This assembly accommodates the fuselage and the ailerons thereof (rescue module), thanks to the cradle thereof and to the hollow shape located at the wing root. The parts (21) (23) and (22) (24) are joined together by fusible bolts [FIG. 17] and hooks [FIG. 16] which are distributed on the cradle and at the ends the ailerons [FIG. 44].

Operating principle of the conversion of the fuselage into the rescue module. This conversion is performed in several steps. The aircraft adopts a down pitch, the speed is a key element for performing this manoeuvre properly. For safety reasons, it is obvious that the latter must be performed in an area free from any population insofar as possible.

The Alpha device [FIG. 20 FIG. 21] (The stabilisers) present in the fin come out of the positions thereof by pivoting to the desired position. The safety hooks which were holding the parts and are locked thus leaving the entire weight of the structure represented by the second part on the sections of the fusible bolts, a simple flare manoeuvre by the pilot or by an artificial intelligence makes it possible to release the rescue module. Thus freed of this excess weight, the devices Sigma and Alpha [FIG. 44] provide this module with flight autonomy like a Rocket aircraft (e.g.: X15, etc.) like the latter, the manoeuvring possibilities being limited, landing is performed on runways long enough to absorb the excess speed.

The intermediate steps described hereinafter give pilots or artificial intelligence further approach possibilities, according to the situation encountered.

Indeed, they provide completely safe landing, thanks to the combination of all the systems present onboard, they provide solutions, when the geographic configurations do not allow it, either because the terrain is not suitable for a long landing or because it is sloping.

Each of the hatches where the electric propulsion means of this rescue module are located are unlocked then are pushed mechanically by two cylinders in translation on the sides and are closed on the arms once they have been deployed thus ensuring minimum drag or fold back up [FIG. 35].

The Theta device [FIG. 35] comes out of its housing by pivoting, the propellers present in the fans thereof rotate.

The orientation of the latter determines the function thereof:

In the vertical position [FIG. 35], the fans enable this rescue module to be towed, during landing, they can be assigned the air brake function, by reversing the airflow of the propellers thereof with respect to the movement of the rescue module.

In the horizontal position [FIG. 41] [FIG. 40], they ensure a vertical landing for this rescue module, they act as parachutes.

The Iota device provides this rescue module with a landing gear enabling it, when the rescue module lands vertically to absorb the impact on the ground, thanks to these links but also to ensure the stability thereof on any type of terrain, including those which are sloping.

The third part of this assembly (the elevator) [FIG. 19] (20) [FIG. 21] (25)

One of the main features thereof results from its dual function. This elevator plays its role in aircraft control but makes it possible in the active phase either to assist with the location of the rescue module, in this case it is a GPS Tracker drone or in the case of a rescue mission to provide additional searching assistance. This drone is located at the end of the fin, held thereby, by a clamp Tau device [FIG. 34]. This aircraft is composed of a wing unit, a smaller flight control surface which is merged with that used by the airplane and an engine providing it with its own autonomy. At the ventral part thereof, two ports are observed [FIG. 43] which enable the passage of the Tau device inside which hooks connected to the structure thereof are located.

This drone has a Phi device [FIG. 21 FIG. 47 FIG. 48] enabling it to be linked to the end of the fin, composed of eight sets of landing gear [FIG. 49] (smart), three symmetrically opposite and two in the longitudinal axis thereof each has two wheels. The three sets of landing gear are mechanically dependent on their opposite counterparts, for gripping. They are composed of a cylindrical base containing a ring gear [FIG. 53], of a tubular arm assembled with this base [FIG. 51]. At the opposite ends, a rectangular-shaped part containing an electric motor equipped with a gear, is mounted on a shaft which links it thereto. At the end of this part, there is a hole which allows the passage of a shaft. On this shaft, the landing gear which is composed of two parts is mounted.

A cylinder which has at the base thereof, a gear [FIG. 52] this is assembled in the rectangular part. At the end thereof, a cylindrical part, which allows a 360° rotation thanks to an electric motor and the cogwheel and pinion system thereof therein. On this cylindrical part, a hub where two electric wheels are located is mounted perpendicularly. Principle of release and deck-landing of this drone.

The device ensuring the stability of the fuselage is actuated. [FIG. 21]. During the release of this aircraft, the stabilisers come out of their positions by pivoting, then are positioned ensuring the stability of the rescue module or the airplane, the Tau device which holds this drone is unlocked [FIG. 34], at this exact time, the drone performed using these flight control surfaces a pitch-up attitude manoeuvre, to move it away from the rescue module. During the “deck-landing”, the manoeuvre is performed in two phases.

First phase, the drone is positioned perpendicularly to the fin, the two sets of gear [FIG. 49] located in the longitudinal axis have the function of damping shocks caused by vertical movements, linked with turbulence. The six symmetrically opposite sets of smart gear have the role of centring the drone transversely, [FIG. 49] the tyres damp any shocks. The articulated arms pivot on the shaft thereof up to the vertical parts of the fin, when the six sets of landing gear are all in contact therewith, the arms produce slightly more pressure, to keep linked to the tail. Once the drone has stabilised with respect to the fin, the second phase starts.

Second phase, the electric wheels are activated and make it possible to the nearest millimetre to position the drone at the planned position so that the locking Tau device FIG. 54 present in the fin takes over. It comes out of its housing and is locked inside the drone at the positions provided for tie-down. The symmetrically opposite wheels pivot on themselves vertically while maintaining the pressure exerted thereby on the panels of the fin. They contribute to the downward movements of the drone, whereas the gear located in the longitudinal axis still in contact with the fin pivots progressively to enter its housings, once the depth has become rigidly connected to the fin assembly, the sets of gear retracting into the positions thereof, as well as the stabilisers (backup elevators).

A counterweight Gamma device is located in the hold of the rescue module and in the GLX5 not shown composed of two shafts rigidly connected to the fuselage whereon a counterweight slides laterally as needed. It makes it possible to vary the centring of the rescue module, during the transition between the different states.

1. Device located at an aerodyne jet engine or engine [FIG. 7] [FIG. 10], said device being capable of generating an airflow from inlet ports [FIG. 2] (2), and or a jet engine or an engine, said airflow being directed by channels and controlled by a turbine (3) located in a wing profile, said device comprising a chamber which surrounds the jet engine of an airplane (FIG. 8: 15), mobile winglets upstream from the thrust reversers and winglets downstream [FIG. 9], (FIG. 10: 16), said winglets being designed such that movement thereof makes it possible to direct the airflow generated by the engine or jet engine from the chamber (15) to a high-lift device located at the wings.

2. High-lift device characterised in that it comprises a device according to claim 1,
Panels (13, 14) moved by an electric motor of which at least one panel is located on the upper surface and the other on the lower surface of a wing profile, and which allow a clearance,
Three successive leading edges in the profile of each wing [FIG. 1] or a cylinder in the profile of each wing (FIG. 2: 3, or FIG. 14).

3. High-lift device according to claim 2 wherein the panels (FIG. 1 or FIG. 2: 13, 14) are mobile and comprise, at the rear ends thereof, a pivot link, and at the front end thereof, two fingers having a cogwheel, said panels being in turn toothed and integrated in toothed grooves [FIG. 1] of the profile and wherein the electric motors are located on either side of said panels and are equipped with cogwheels, ensuring the mobility of said panels.

4. High-lift device according to any one of claims 2 to 3 wherein the first leading edge is fixed and integral with the wing, and comprises a tube wherein the ends are occluded and comprise a slot (1) on the flank allowing the passage of an airflow [FIG. 1] inside the leading edge, a pipe connects this tube to a turbine,
the second leading edge comprises two mobile parts [FIG. 1] (4, 5) joined by a shaft (FIG. 1: 6 of FIG. 4: y1) whereon two push cylinders (FIG. 5: 7) located at each end of a (FIG. 5: 8 or y), allow a longitudinal clearance which renders this assembly rigidly connected to the shaft (8), this shaft (8) consists of one or more cam(s) (FIG. 5: 9), the rotation thereof (8) enables the rotation of the two mobile parts (FIG. 1: 4, 5), which allows different angular settings, the assembly (FIG. 1: 4, 5, FIG. 5: 7, 8, 9) is held by a cylinder (FIG. 3: 10) located on each side of the shaft, the third leading edge (FIG. 2: 11) covers all of the first two leading edges and is held by two cylinders having a longitudinal displacement and which are fastened inside the wings (FIG. 3: 12).

5. High-lift device according to claim 2 in respect of the second version the leading edge a machining of two notches on the flank of the cylinders determines the angle whereby the airflow emerges therefrom to flow on the upper surface and lower surface simultaneously.

6. High-lift device according to claim 5 wherein the cylinder is mobile and rotatable on a shaft (x) (FIG. 14: x), rotation and locking being carried out by cogwheels (19) in contact with ends (shaft x1).

7. Aerodyne comprising a high-lift device according to any one of the preceding claims.

8. Airplane security device (ASD), comprising at least three parts, including a fuselage equipped with two ailerons, stabilisers, and four motors (theta device) (FIG. 44).

9. Airplane security device according to claim 8 wherein the fuselage equipped with these ailerons and these stabilisers can be detached, respectively from the two wings and an elevator [FIG. 19 [FIG. 20, depth: 25] [FIG. 21: 23].

10. Aileron of symmetrical convex shape capable of being integrated in the body of a wing of an airplane or a glider [FIG. 21]: (24) FIG. 19: according to FIG. 22; or FIG. 23].

11. Airplane or glider wing comprising an aileron according to claim 10 and a part for fastening said aileron.

12. Airplane cradle whereon the structure of the wings is mounted, characterised by a biconvex shape of the hollow part located at the root of the wings accommodating the ailerons of a rescue module.

13. Stabiliser device (FIG. 47 or FIG. 48) located at the rear end of the fuselage characterised by the conical shape thereof and the shaft thereof allowing it to accommodate mobile stabilisers having the same base, comprising two symmetrically opposite ailerons equipped with flight control surfaces, off-centred with respect to the centre of the cone, thus positioned at the fin, which enables it to be integrated in the vertical tail, to decrease the drag.

14. Device [FIG. 35] [FIG. 40] allowing the passage of a shaft which connects an arm and fan assembly to a fuselage structure [FIG. 37], said arms being capable of pivoting on a shaft (x) via electric motors not shown, the device optionally comprising or comprising:
four fans housed inside a compartment, each fan being composed of a hollow arm of cylindrical shape, assembled perpendicularly to the arm,
a cylindrical base comprising on the flank at least one hole enabling the assembly of the constituent elements of this device [FIG. 39].

15. Aerodyne comprising any one of the devices claimed above or a combination of these devices.

16. Device according to claim 8, the third part of this assembly (the elevator) [FIG. 19] (20) [FIG. 21] (25). One of the main features thereof results from its dual function. This elevator is a rescue module in the active phase, and has an articulated landing gear providing it with multiple possibilities.
